(19) United States
(12) Patent Application Publication
(10) Pub. No.: US 2002/0154157 A1
(43) Pub. Date: Oct. 24, 2002

(54) Website system and process for selection and delivery of electronic information on a network

(76) Inventors: Scott Jeffrey Sherr, Brentwood, CA (US); Ira Steven Rubenstein, Los Angeles, CA (US); Yair Landau, Pacific Palisades, CA (US); Andrew C. Frank, New York, NY (US); Brian David Lakamp, Malibu, CA (US); Bryan Gentry Spaulding, San Francisco, CA (US); Charles Jonathan Evans, New York, NY (US); Everton Anthony Schnabel, Los Angeles, CA (US); Hartmut Ochs, Los Angeles, CA (US); Jeremy Eli Barnett, Pacific Palisades, CA (US); Seth David Palmer, New York, NY (US); Todd Michael Henderson, Pacific Palisades, CA (US); William W. Chong, New York, NY (US); Bruce Forest, Weston, CT (US); Steven Koening, Menlo Park, CA (US)

Correspondence Address: Foley & Lardner, 35th Floor, 2029 Century Park East, Los Angeles, CA, 90067-3021, US

(21) Appl. No.: 09/828,406

(22) Filed: Apr. 6, 2001

Related U.S. Application Data
(60) Provisional application No. 60/195,870, filed on Apr. 7, 2000.
(60) Provisional application No. 60/273,444, filed on Mar. 5, 2001.

(51) Int. Cl. G09G 5/00

(52) U.S. Cl. 345/716

(57) ABSTRACT

A user interface for use with a content items delivery apparatus and method which simulates the look and feel of a video rental store. Rental of the content items occurs within an online environment including one or more client computers and at least one network server connected by a communications link to the one or more client computers. The method includes providing access to an online catalog stored within a memory of a network video server computer and displayed on a main website. The online catalog includes information regarding digital video signals available for rental from the network server computer. The digital video signals may be displayed as virtual video boxes on a virtual carousel or on virtual shelves. The user may select a digital video signal and purchase a license to view the selected digital video signal based on an access level selected by the user.

### RELATED APPLICATIONS

This application claims priority to Provisional Application No. 60/195,870, filed Apr. 7, 2000, and to Provisional Application No. 60/273,444, filed Mar. 5, 2001, each of which is hereby incorporated by reference. The present invention also relates to U.S. patent application Ser. No. 09/603,805, filed Jun. 20, 2000 (for which a Petition to Convert Non-Provisional Application to Provisional Application Under 37 CFR 1.53(c)(2) was filed Mar. 16, 2001 via U.S. Express Mail Label No. EL752586903US, our file number 041892-0208, decision of petition and provisional serial number unknown at this time), is incorporated herein by reference and which forms a basis for priority. The present invention also relates to U.S. patent application Ser. No. ______ , titled “Online Digital Video Signal Transfer Apparatus and Method,” filed Apr. 4, 2001 (attorney docket no. 041892.0207), which is incorporated herein by reference and which forms a basis for priority. The present invention also relates to U.S. patent application Ser. No. _______ , titled “Secure Digital Content Licensing System and Method,” filed Apr. 6, 2001 (attorney docket no. 041892.0203); and U.S. patent application Ser. No. ______ , titled “System and Process For Delivery Of Content Over A Network,” filed Apr. 6, 2001 (attorney docket no. 041892.0206), each of which is incorporated by reference in its entirety.

### BACKGROUND OF THE INVENTION

1. Field of the Invention

Embodiments of the present invention relate to apparatuses and methods for selection and delivery of electronic information to recipient processors on a network, and in example embodiments, to apparatuses and methods for online selection and delivery of electronic content to network users, including, but not limited to motion picture files to rental customers over the Internet. Further example embodiments relate to the online selection and delivery of other forms of electronic information, including, but not limited to music or other audio, still images, game programs, application software, electronic books, or other electronic content.

2. Description of Related Art

In modern network environments, including the Internet, various forms of electronic content are made available to network users. For example, Internet users may access a variety of Internet sites to download electronic files containing music, videos, images, games, or other content. Typically, such Internet sites provide a list of content titles from which a user may select a particular piece of content by its title, for example, by directing a cursor to one of the titles in the list.

The capability to provide electronic content to online users over the Internet has created opportunities to conduct various forms of electronic commerce (or Ecommerce), for example, to provide services for selling or renting electronic content. One example online provider of a service for delivering electronic movie videos to end users on demand, is Tranz-Send Business Network (TSBN).

The success of a content service on the Internet may depend, at least in part, on the ease by which a user may select and access content. Services that provide websites having formats or displays that are unfamiliar or complicated to typical users may have difficulty in attracting a sufficient number of users to the website and generating repeat users. Thus, there is a demand for user interfaces, such as websites, which are easy to operate and provide familiar or recognizable formats.

On the other hand, services with websites that have highly standardized or typified formats, such as clickable list formats, for selecting content by titles (or brief descriptive text) can be boring and unattractive to users and can be indistinguishable from other sites. Moreover, in some contexts, a title or general description of a piece of content, as might appear in clickable lists or menus on websites, may not provide sufficient information or inducement for the user to select that piece of content. Thus, there is a demand for user interfaces, such as websites, which are not only easy to operate, but also provide a distinguishable format, an opportunity to obtain various types of information about content pieces, and an inducement to select content pieces.

### SUMMARY OF THE DISCLOSURE

Therefore, it is an advantage of embodiments of the present invention to address the above-described industry demands. According to one embodiment, a user interface comprising an Internet website provides a stimulating and recognizable format that allows users to easily identify and select content pieces. According to a further embodiment, the website includes an electronic display format that simulates a format in which packaged recordings of content pieces are typically displayed to customers visiting conventional brick-and-mortar business establishments.

In example embodiments in which the content comprises electronic movie files, a website provides a user interface for selecting one or more movies, where the movies may be selected from an electronic display showing images or representations of boxes or packages, including box art, of the type that is typically present in a conventional movie video rental store. Similarly, an interface for selecting music content pieces may include an electronic display showing boxes and box art typically present on music CD (compact disc) boxes, tape boxes, album covers, or the like, in conventional music stores. Further embodiments include an electronic display of multiple boxes or packages in a moving display to simulate a carousel rack, shelves or other display rack typically present in a conventional movie rental store, music store, video game store, or the like.

According to a further embodiment, the website includes mechanisms by which additional information about content pieces is provided to the online user, either automatically or upon request by the user. In one embodiment, such additional information comprises one or more segments or clips of an associated content piece, for example, segments of a movie, video game or a music piece. In other embodiments, such additional information comprises one or more precomposed short productions designed as a promotional tool for an associated content piece, for example a trailer for a movie.

It is a further advantage of embodiments of the present invention to provide systems and processes associated with providing a website as described above, receiving payment, and controlling access to and licensing of content within an online environment. In a system embodiment, one or more servers located at one or more network nodes include software, hardware and/or firmware for providing a website as described above. Each user employs a recipient processor having software, hardware, firmware or combinations thereof for accessing the website over the network, interacting with the website, controlling user access to content based on rules incorporated in content licenses and playing (or otherwise making available) content to the user when license terms are satisfied.

In one example embodiment, a system and method provides users with access to an online catalog stored within a memory of a network video server computer, for displaying on a user interface, such as a website. The user may select from various search, browse and display options relating to content available through the website. By using those options, a user may find and submit a request for a content piece. The requests may include electronic payment based on a defined level of access to the selected content. Once electronic payment is provided, a license to access the content may be generated for the client. Once the user has obtained a valid license, the content may be converted by a user's processor into a user-perceptible form, for example, an unlimited number of times or a defined number of times during a defined time period, based on the defined level of access.

Thus, one embodiment of the present invention provides a user interface that simulates the actual rental of motion pictures within a video rental store. Moreover, in one embodiment, during the defined rental period, the user is allowed to view the motion picture as many times as desired, thereby simulating the actual rental of feature length motion pictures.

These and other advantages are accomplished according to apparatuses and methods for selection and delivery of content to recipient processors.

### BRIEF DESCRIPTION OF THE DRAWINGS

Embodiments of the present invention are illustrated by way of example, and not by way of limitation, in the figures of the accompanying drawings and in which:

FIG. 1a is a generalized schematic representation of a network environment in which embodiments of the present invention may operate.

FIG. 1b is a generalized schematic representation of some of the components of a website server which may be employed with embodiments of the present invention.

FIG. 2 illustrates a display of a main website home page according to an embodiment of the present invention.

FIG. 3 illustrates a display of a main website recommendation page according to an embodiment of the present invention.

FIG. 4 illustrates a display of a main website MyList page according to an embodiment of the present invention.

FIG. 5 illustrates a display of a main website browse page according to an embodiment of the present invention.

FIG. 6 illustrates a display of a main website search page and interface for entry of search criteria and display format according to an embodiment of the present invention.

FIG. 7 illustrates a display of a main website search page and interface for entry of genre criteria according to an embodiment of the present invention.

FIG. 8 illustrates a display of a main website search page showing the results of a genre search according to an embodiment of the present invention.

FIG. 9 illustrates a display of a main website movie page according to an embodiment of the present invention.

FIG. 10 illustrates a display of a main website order page according to an embodiment of the present invention.

FIG. 11 illustrates a display of a main website checkout page according to an embodiment of the present invention.

FIG. 12 illustrates a display of a main website download page according to an embodiment of the present invention.

FIG. 13 illustrates a display of a main website unlock page according to an embodiment of the present invention.

FIG. 14 illustrates a display of a main website open order ticket page according to an embodiment of the present invention.

FIG. 15 illustrates a display of a main website registration page according to an embodiment of the present invention.

### DETAILED DESCRIPTION OF PREFERRED EMBODIMENTS

Embodiments of the present invention relate to apparatuses and methods for selection and delivery of electronic information to recipient processors on a network, and in example embodiments, to apparatuses and methods for online selection and delivery of electronic content to network users, including, but not limited to motion picture files to rental customers over the Internet. Further example embodiments relate to the online selection and delivery of other forms of electronic information (or content). The term “content” is used herein to refer to all forms of electronic information (information that may be read or processed in an electronic form), including, but not limited to electronic files, streamed data, or other data formats for movies, video, music or other audio, still images, game programs, application software, electronic books, or the like.

Systems and methods according to example embodiments of the present invention may be employed to provide a content renting, selling or lending service, wherein access to electronic content as described above may be provided to users who have purchased or otherwise obtained a valid license on a network. Other embodiments may be employed in other contexts in which access to content is controlled over a network. For purposes of simplifying the present disclosure, embodiments are described herein with reference to a content rental system or process and, in particular examples, to such a system or process wherein the content comprises an electronic, digital copy of a movie. Many aspects of the invention, however, are not limited to movie rental systems and processes, and may be employed in embodiments relating to other types of content and/or other distribution contexts, including, but not limited to, content selling, content lending, controlled or directed distribution of content or other suitable contexts in which access to content is controlled.

Similarly, the description focuses on implementations for a network server computer system accessible through the World Wide Web and the Internet as a website (referred to as the “main website”). However, many or all of the methods and apparatus described may be readily adapted to other data connections as well, including, but not limited to, other Internet connection interfaces (for example, an FTP server), private networks (for example, a network provided by an ISP for its subscribers), and direct connections (such as a directly wired set of stations in a limited area such as a hotel, office building, educational facility or the like).

In addition, implementations are described in which the user accesses and downloads electronic files using a computer system, which may be a personal computer system or other suitable computer system. However, many or all of the methods and apparatus described may be readily adapted to other network-enabled devices employed to access and download data through a server, including, but not limited to, a television with a connected or internal cable modem and hard disk, set-top-boxes (STBs), personal digital assistants (PDAs), mobile telephone devices, AVHDD devices (such as a SONY “Tivo” device) or any other suitable network enabled device with a storage device for storing content and/or a play or display mechanism for playing or displaying content to the user.

System Hardware Environment

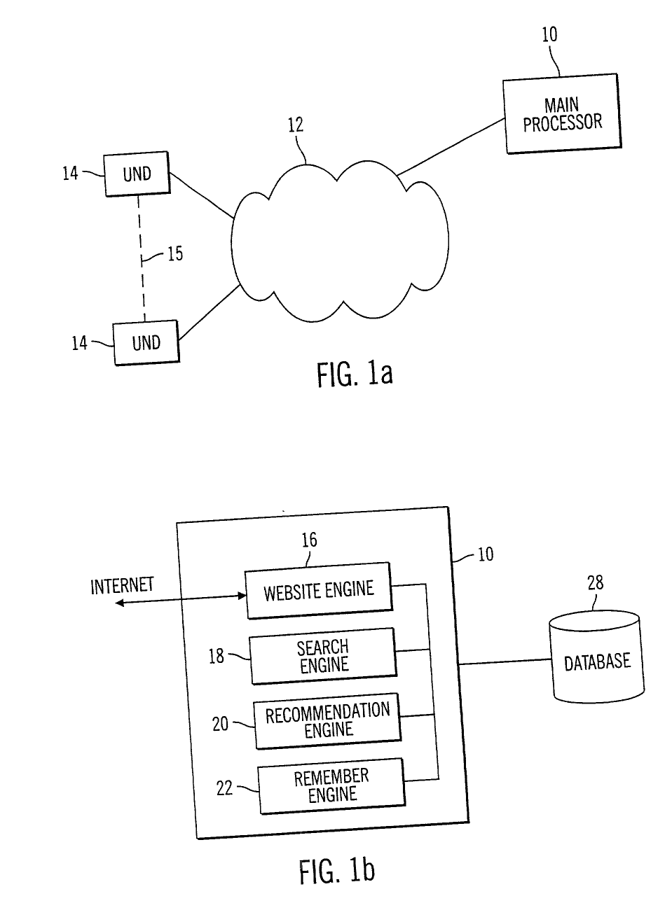

An example system hardware environment employed with embodiments of the present invention is shown in FIG. 1a, wherein a main processor (or main server) 10 is connected for communication on a network 12 to one or more recipient processors (or user network-enabled devices (UNDs) as described above) 14. In other embodiments, more than one main server 10 may be employed, for example, for load distribution or for redundancy in the event that one main server fails.

The main processor (or main server) 10 may be any suitable server computer system or other processor system programmed or configured to interact with the UND 14, to provide a user interface for allowing a user to select content. The main processor 10 may be composed of multiple processors connected together or connected over the network and coordinated to operate, for example, as described herein.

In one embodiment, the interface provided by the main processor 10 comprises a main website accessible to users on the network 12, such as, but not limited to, the Internet. In website embodiments, the server computer system 10 may include or operates with a memory system for storing website content, comprising data for creating or generating text, images, designs or other indicia that compose one or more pages of the main website. A generalized representation of some components of an example main server is shown in FIG 1b, wherein the main processor 10 includes a website engine 16 for generating website content as described herein. The main server may also include a search engine 18, a recommendations engine 20 and a remember engine 22, as described below. Functions of those engines are described below. Further engines, such as a transaction engine (not shown) may be included to provide transaction functions as described below. The main processor 10 may include or operate with one or more memory devices containing data, such as a database 28. Data stored in the database 28 may include user information (including identification, demographic, historical activity, MyList selections) or other information employed by the main processor 10, to perform functions as described herein.

The UND 14 may include or operate with a processor, a display device and memory storing browser software or other suitable software, hardware, firmware or combinations thereof, for interacting with the main server 10 over the network 12. In website embodiments, the UND 14 may operate with browser or other suitable software to access the website and display website content to the user, for example, in a conventional manner of Internet communications. As described in more detail below, the UND may also include content playing software, hardware, firmware or combinations thereof, for converting electronic content items into user-perceptible content. When a UND 14 is connected in communication with the main processor 10, the website may be displayed on the user's device as a user interface, for allowing a user to receive user-perceptible information from the main processor 10 and communicate information to the main processor 10, such as requests for content or requests to link to additional pages or other sites.

System and device functions and processes described herein may be implemented with machine-executable instructions. Software comprising these instructions may be used to program and cause general-purpose or special-purpose processors (the main processor or server and the recipient processors, depending upon the function or process being performed) to perform the functions and processes described herein. Alternatively, such functions and processes may be implemented by firmware, hardware comprising hardwired logic, or by any combination thereof.

In one example embodiment, users may be provided with computer program products comprising a machine-readable medium storing software for programming a computer (or other UND as described above) to perform processes carried out by the UND relating to the management of user access to secured content, according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions.

In another example embodiment, UNDs (recipient processors) are programmed with software downloaded to the UNDs as computer program products. The software may be downloaded or transferred from a remote processor (for example, a server) to a requesting processor (for example, a UND) by way of data signals embodied in a carrier wave or other propagation medium via a communication link (for example, a modem or other wired or wireless network connection, a satellite signal receiver or other broadcast signal receiver, or the like).

Network Site Interface or Website

A system and process according to one example embodiment of the invention provides a service for selecting content items, such as, but not limited to, movies to be played by the user. The system and process may employ any suitable network structure, including, but not limited to the Internet. The system and process may provide several functions such as, but not limited to, (1) browsing and selecting a content item (for example, a movie) for download; (2) paying for a license, such as a usage-limited or time-limited license; (3) downloading the content item (for example, a selected movie) in an encrypted electronic file; and (4) enabling accessing (for example, viewing) of downloaded content (for example, a downloaded movie) according to the purchased license.

In one embodiment, the system and process comprises providing a main site which may be accessed by UNDs over the network, such as, but not limited to a main website on the Internet. In an Internet embodiment, users may connect to the main website through the Internet with a UND (or recipient processor) as described above. On the main website, users may browse and search for information regarding content items (for example, movies) available through the website, access samples of content items (such as view images of movies), and obtain licenses to access content items (for example, purchase licenses to rent movies).

The user connects to the main website across the Internet, using a personal computer or other suitable network enabled device, as described above. In one embodiment, the UND may employ standard web-browsing software to connect to and interact with the main website. In other embodiments, customized software, hardware, firmware or combinations thereof, may be employed by the UND for interacting with the main processor (or website server). The user may connect to the main website by, for example, connecting to the address or uniform resource locator (URL) associated with the main website.

The user may browse through website content, such as text, audio and images displayed on the main website. The website content includes text, audio and/or image information describing further content (for example, movies) that may be rented, purchased, loaned, ordered or otherwise obtained through the service. In the present disclosure, for purposes of distinguishing the website content (text, audio, images displayed on the website) from further content items (such as movies) that may be rented, purchased, loaned, ordered or otherwise obtained through the website, such further content will be referred to as “content items,” while content displayed on the website is referred to as “website content.”

The main website may contain a home page and a tree of numerous additional web pages inter-linked with the home page at the root. The pages of the main website may present various information to the user, such as, but not limited to, descriptions of content items (for example, movies), still images, clips (segments of a content item, for example a movie clip, viewed in its normal manner, and streamed to the user's processor), and trailers (packages of clips and special audio typically used to promote a content item, such as movie trailers commonly shown as previews of a coming movie, streamed to the user's processor). The user may browse through the website by following links within the pages of the website or by using various tools, such as, but not limited to, a search tool, a virtual carousel rack presentation of movies, user selectable operators such as virtual buttons (designated selectable icons or areas) and menus, lists, and the like.

For example, a search engine may be available to the user on the website, for searching for content items available through the website. The search engine may operate by using specific information received from the user, such as words from movie titles, movie categories or characteristics (western, comedy, biography, or the like), names of actors, actresses, directors, producers, or other suitable information for directing a search among a plurality of content items.

When the user has found the content item (for example, movie) that the user would like to access, the user may pay a license fee, for example, using a credit card or other suitable form of payment or recordable remuneration. This fee purchases a limited license to access the selected content item (such as view a selected movie). The user may then download the license and the selected content item (for example, the selected movie) through the network. Alternatively, the content item (for example, movie) may have been downloaded from a previous visit to the website or downloaded to the UND in other manners, such as a file already pre-loaded onto the UND at the time of purchase of the device, a file transferred to the UND from another computer device, or a file loaded to the UND from an external storage medium, such as a computer readable disc or other storage medium. In one embodiment, a content item (such as a movie) may be downloaded to a UND from a server on the network other than the main server, for example by communicating a network address or other suitable identifier for the content server from the main server to the UND. A license may be purchased either at the time of selecting the content item or at a later time when the user desires to play (or otherwise access) the content item (for example, play the movie).

When a content item (such as a movie) is transferred from a first UND to a second UND, as described above and as represented by broken line 15 in FIG. 1a, it may be transferred by various methods. In one embodiment, the content item (such as a movie) is transferred from the first UND to the second UND via computer readable disc or other storage medium. Using this method, the user of the first UND would first transfer the content item from the the first UND to the computer readable disc or other storage medium. The computer readable disc or other storage medium would then be physically transferred to the location of the second UND and the content item transferred from the computer readable disc to the second UND. In other embodiments, the content item may be downloaded from the first UND to the second UND over a network (such as the Internet). The user on the second UND will not be able to access (open or view) the downloaded content item until and unless the user obtains a license, as described above. The user of the second UND may obtain a license for the content item by connecting the second UND to the website and requesting the license.

In another embodiment, a first UND may connect to the website and may have access to content items (such as a movies) that are resident on other UNDs that are also connected to the website. This access may be implemented, for example, by a file-swapping user interface provided by the website that displays to the user, in graphical or textual form, the content items resident on the other UNDs which may be transferred to the first UND. The user of the first UND may obtain a license for the transferred content either at the time the transfer is made or during a later visit to the website. Thus, the website would facilitate the swapping of content items between users of the website. However, a license must be obtained before the swapped content items may be accessed (for example, viewing a movie).

While the actual sequence of events and operation of the main pages of the website vary with different embodiments, in one example embodiment a user first connects to the website using a web-browser. The user then logs into the website with a user identifier and password or logs in as a guest. A new user may also register with the website to establish a user identifier and password. During the login process and registration, the main website derives information about the user's processor or computer system to provide proper support for the user's interaction (for example, to determine the type of streaming files to use). Examples of registration processes and functions are described in further detail below. The user identifier associates the user with a customer account on the website. In a preferred embodiment, the customer account may be customized to the particular user. For example, the home page may greet the user by name.

A user profile may be associated with each user account, to record information relevant to the customization of the customer account. In one embodiment, the user may specify items in a user profile to cause aspects of the main website to be displayed in a certain way for that user, such as to always display text lists. In addition, the user may utilize the user's associated identifier to access account information, such as content items (for example, movies) rented but not unlocked (called “Open Order”), or content items (for example, movies) previously marked by the user as being of interest to the user (called “MyList”).

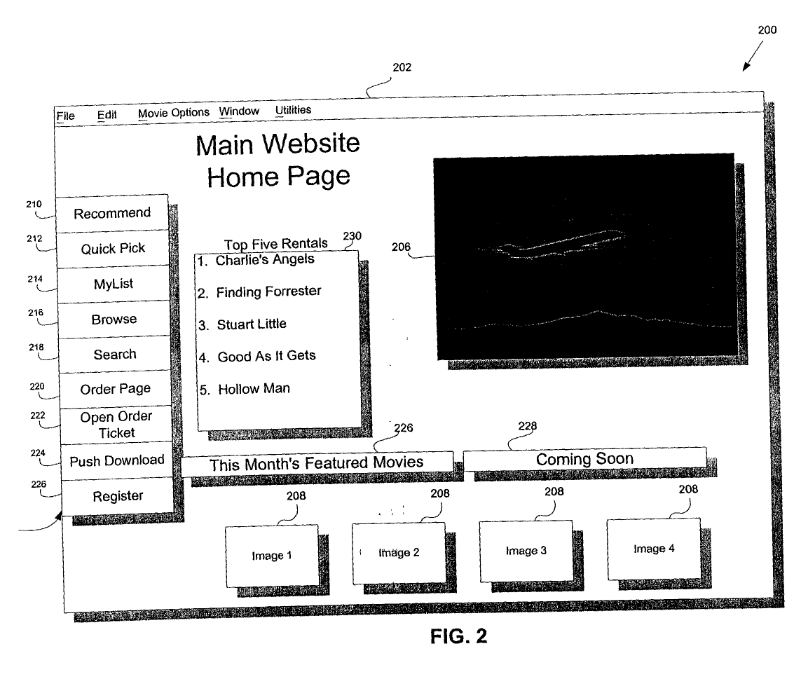

The website content and the arrangement of website content on website pages may vary, depending upon the embodiment. FIG. 2 depicts a representative example of a display of a website home page 200 with the browser of a UND. It will be understood that many aspects of the invention are not limited to the specific website content or the arrangement of website content shown in FIG. 2.

In the FIG. 2 example, a menu bar 202 is located along the top of home page 200. An option menu 204 is located vertically along the left side of the screen. A row of images 208 associated with several content pieces (such as movies) is located horizontally along the bottom of home page 200. In the upper right comer of home page 200 is a display area for a streaming box 206.

As described below, various aspects of the home page and other pages of the website may be customized for particular users or defined groups of users. Such customized website pages may include website content, arrangements of content, user options and the like, which are customized toward user preferences or needs. In one example, a user accessing the website would be identified by, for example, user identification information input by the user, identification information automatically communicated by the UND operated by the user, or the like.

The website server (or an associated processor) may employ the identification information to associate one or more characteristics relevant to content preferences or needs of the user, for example, by looking up prestored information about the user's past activity on the website, elsewhere on the network and/or on the UND operated by the user. Various algorithms, analysis tools and services are available to detect and evaluate such user activities and render probable user preferences therefrom. Each time a user accesses the website, other network sites, and/or particular applications on the UND, information relating to the user's activities may be stored for use with such algorithms, analysis tools or services. The user activity information for a particular user may be stored, for example, in a file or other memory structure (for example, a cookie) in the UND operated by that user for communication to the website server when the user accesses the website, for example, during an initialization or handshaking routine or at some time after the user connects to the website. Alternatively or in addition, user activity information may be stored and maintained in a database at the website server (or network location accessible by the website server). In one embodiment, software (such as a cookie) on each UND detects and records user activity information occurring on that device, while software on the website server (or associated processor) obtains the user activity information from the UND and employs that information to determine potential or likely user preferences.

A menu bar 202 may be included in conjunction with website content comprising the website home page, to provide commands such as, but not limited to, File, Edit, Movie Options, Window and Utilities commands that allow the user to perform various functions such as printing, saving files, editing text, selecting movie options, and the like. The menu bar 202 may be provided by the browser software on the user's device and/or as part of the website content.

Options menu 204 presents the user with various options on which the user may click or otherwise select (for example, by pressing a particular key combination) to perform an appropriate action. For example, in one embodiment options that may be available to the user from options menu 204 may take the user to a new page, such as a commercial transaction page or a registration option that allows the user to jump to a page suitable for registering the user on the website.

Each image 208 may include information corresponding to a piece of proprietary content (such as a movie). Each image 208 may comprise an image of a portion of the corresponding proprietary content or an image representing a recognizable feature of the corresponding proprietary content. In one embodiment, each image 208 comprises a visual representation that simulates a format, package or box in which recordings of content pieces are typically displayed to customers visiting conventional (for example, brick-and-mortar) business establishments. Thus, each image 208 may comprise a representation of a standard box or package in which the proprietary content is typically contained. In one embodiment, the images 208 may be controlled to appear to move toward the right or left, to simulate a carousel rack movement as described in more detail below.

In examples in which the proprietary content comprises movies, each image 208 may comprise a visual representation of a standard box or package (including the package art or box art) in which video tapes, video discs or other recording media is typically contained in a conventional movie video rental store. Similarly, an interface for selecting music content pieces may include an electronic display showing boxes and box art typically present on music CD (compact disc) boxes, tape boxes, album covers, or the like, in conventional music stores. In other embodiments, text items, icons or other suitable indicia items may be included with or as an alternative to images 208.

Representations of packages or boxes, including box or package art, are referred to herein as virtual boxes (for example, virtual video boxes). Thus, a virtual box refers to a collection of images from a package or box in which pre-recorded content items are or may be contained in typical brick-and-mortar style business establishments. In one embodiment, the virtual box may be designed to resemble the standard physical box used to package the specific content item associated with the box (for example a standard video box, including the box art, designed and used for the video tape, CD or the like associated with the specific content item). Alternatively, the image on the virtual box may be a special online version designed for the website service.

Each image (or alternative indicia) 208 comprises or is associated with a user-selectable icon or indicia, which may be selected by any suitable means, including, but not limited to directing a cursor to the image 208, clicking on the image 208, actuating one or combinations of keys, a touch screen or the like. When the user selects one of the images 208, additional information about the content piece (for example, movie) associated with the selected image is provided. Such additional information may include text describing the associated piece of content, links to websites related to the associated piece of content (for example, a page or website to purchase a physical copy of the content item, a page in a movie index website, the official website for the movie sponsored by the owner of the movie, or the official website for the soundtrack of the movie), clips, or a trailer for the associated content (such as a movie clip or a movie trailer) or audio information (for example, audio samples from the associated content or audio information about the associated content), which may be displayed or played to the user. Such additional visual information may be displayed in place of the selected image 208 or in a further area of the website page display, such as the streaming box 206. In addition or as an alternative, selection of an image 208 may enter the user into a transaction to purchase or otherwise obtain a license to access the associated content (for example, view the movie associated with the selected image 208). In some embodiments, if the content item is unavailable from the website at that time, the website may redirect the user to a preferred source (such as another website) to allow the user to obtain the movie. When the movie is again available on the website, the website will stop redirecting the user to another source.

In a further example embodiment in which the images 208 represent boxes or packages for pre-recorded content items, the user may be provided with an option of rotating each image 208 to show, for example in 3D, representations of other sides of the boxes or packages. For example, by directing a cursor to one of the images 208 and actuating a mouse button (for example, but not limited to, a left click), the image 208 may be made to appear to rotate to show other sides, including the back side, of the represented box or package. In this manner, artwork or other information that may normally appear on the back or side surfaces of a conventional box or package may be displayed to the user in a format that is familiar to or readily understood by the user. In other embodiments, other means for allowing a user to cause a selected image 208 to rotate may be employed, including, but not limited to, one or more user-inputted key strokes, a selectable icon or area on the home page, or the like.

The streaming box 206 may also be used to display information about one or more content pieces, for example, selected by the content service operator as promotional information for such content pieces. For example, information regarding new or popular content pieces (such as movies) may be displayed within the streaming box 206. Alternatively, or in addition, information relating to content pieces associated with predefined user preferences may be displayed within the streaming box 206, as described in more detail below. The user may select the streaming box 206 by, for example, but not limited to, directing a cursor to the image 208, one or combinations of key strokes, touch screen control or the like. Prior to selection of the streaming box, the streaming box area of the home page display may be blank or may include one or more still images associated with the promoted content pieces or other suitable indicia. Once selected, the streaming box may be activated to display promotional information, for example, a clip or trailer of a movie as described above. Alternatively, one or more clips, trailers or other promotional information may begin playing (begin video and/or audio sequence) automatically when the home page is accessed. The process of playing a clip or trailer in the streaming box 206 is also referred to in the present application as “staging” the clip or trailer.

Home page 200 may also include selectable icons or areas that control the images 208, including, but not limited to, a “featured” icon or area (such as a “featured movies” icon) 226. In response to a user selecting the “featured” icon or area, the images 208 display information relating to proprietary content items featured by the service operator for special promotion, for example, for promotion during a specified period of time (such as “This Month's Featured Movies”). The home page 200 may also include a “coming soon” icon or area 228. In response to a user selecting the “coming soon” icon or area 228, the images 208 display information relating to proprietary content items that will be available in the future, but are not yet available through the service (for example, upcoming movies). The home page may similarly include a “most popular” icon or area, such as a “top 5 rentals” area 230. In response to a user selecting the “most popular” icon or area, the images 208 display information relating to proprietary content items that are accessed most often (such as the X most often accessed content items, where X is any suitable number, including 1, but preferably greater than 1).

As an alternative, in response to a user selection of the “featured,” “coming soon” and/or “most popular” icons or areas, a separate display area on the website may be employed to display information associated with featured content or upcoming content to the user. The separate display area may comprise another portion of the home page display (such as, but not limited to the streaming box 206), a window that opens over the home page display, another page of the website or other suitable display location.

The user may enter into a transaction to purchase or otherwise obtain a license to access a proprietary content item (such as a license for rental of the movie), for example, by clicking on an image 208 (for example, a video box) or selecting or entering a command (for example, an “order” or “order page” command) . In one example embodiment, the website may distinguish between a left click on an image 208, which may be used, as described above, to show more information about the associated content item or to start a clip or trailer of the associated content item, and a right click, which may be used to enter an “order” page to rent the movie (either directly or through a pop-up menu).

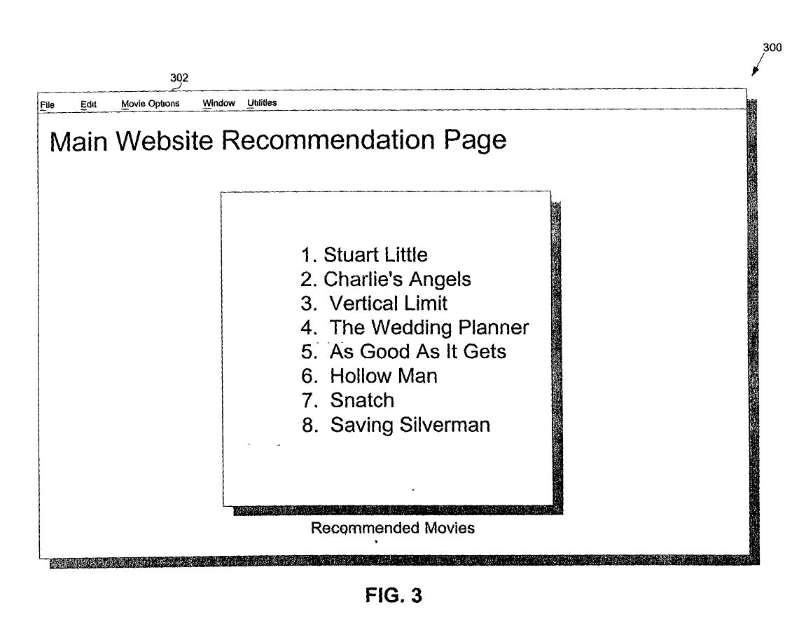

As described above, an options menu 204 may be provided to present the user with various options on which the user may click or otherwise select. In one example embodiment, the options menu 204 may include an option to receive recommendations of content items (such as recommended movies to access through the website). When the user selects “recommend” icon or area 210, a “Recommendation Engine,” which may, for example, be implemented in software routines, provides the user with a recommendation display, a recommendations window, a recommendations page or the like, displaying information about recommended or suggested content items (such as movies). An example of a recommendations page 300 is shown in FIG. 3, where a recommendations list identifies eight movies, by title. Any suitable number of content items may be identified in the recommendations list display. Any suitable identification information may be employed to identify content items in the recommendations list, including, but not limited to a title, descriptive text, an image, a graphical design or the like.

In one embodiment, the Recommendation Engine will track user activity on the website or elsewhere on the network, for example on other websites, to determine preferences of a given user. Thus, user activities relating to previous selections of content, previous purchases, websites visited by the user, software programs operated by the user or other activities of the user may suggest user preferences. Various algorithms, analysis tools and services are available to detect and evaluate such user activities and render probable user preferences therefrom. Thus, in the context of a movie rental service, the Recommendation Engine may employ a given user's history of visiting websites relating to classic automobiles as part of a determination that the user may have a preference for action movies having car chase scenes.

Alternatively or in addition, the Recommendation Engine may suggest content items (such as movies) based on user responses to inquiries or a questionnaire on the main website or elsewhere on the website (or otherwise received by the service operator, for example, through postal mail, electronic mail, or the like), or based on the user's evaluation of other content (such as other evaluations of other movies). In yet another embodiment, the Recommendation Engine may make movie suggestions based on a combination of the above-described factors.

The user may then select one of the recommended content items (such as movies), for example, by directing a cursor to the selected entry in the list, clicking on the corresponding entry in the list, touching the screen of a touch screen input device at the location of the selected list entry, entering the number or other identifier corresponding to the selected content item on a keyboard or other user-input device, or the like. The user may also be presented with options on menu bar 302 that allow the user to select a particular content item (such as a movie). Once selected, more information about the selected content item (such as a selected movie) may be displayed to the user, for example, on a display shown on another portion of the Recommendation Page, on a window opened over the Recommendation Page, on a separate page to which the user is directed (such as a movie page associated with the selected movie). Alternatively, or in addition, once a content item on the recommendations list is selected, the user may be presented with the option of purchasing or otherwise obtaining a license to access the selected content (such as, a license to rent the selected movie), for example, by displaying information or indicia for placing an order for the selected content. Such order information may be displayed on a portion of the Recommendation Page, on a window opened over the Recommendation Page, or on a separate page to which the user is directed (such as an Order Page) upon selecting a content item in the list.

The Recommendation Engine may be used in further embodiments to select a trailer or clip or other information relating to a content item (such as a trailer or clip of a movie) to be played in streaming box 206 on the user's customized home page. Thus, for example, the trailer or clip that the user sees upon accessing the user's customized home page may be tailored to the user's preferences.

Further, extended information such as, but not limited to, reviews (for example, movie reviews), ratings, inside industry information (for example, cast interviews), a movie synopsis or production information, links to a relevant network site (such as links to the Internet Movie Database (IMDB)), or the official website for the content item (such as the official site for the movie or soundtrack, may be provided to the user based on content items (for example, movies) selected by the Recommendation Engine.

In addition, in one embodiment, a content item (such as a movie) selected by the Recommendation Engine may be downloaded to the user by selecting a “Quick Pick” icon or area 212 on options menu 204, shown in FIG. 2. When a user selects the Quick Pick icon or area 212, the Recommendation Engine picks a content item (such as a movie), the main website completes a commercial transaction to purchase or otherwise obtain a license for the selected content item (for example, a movie).

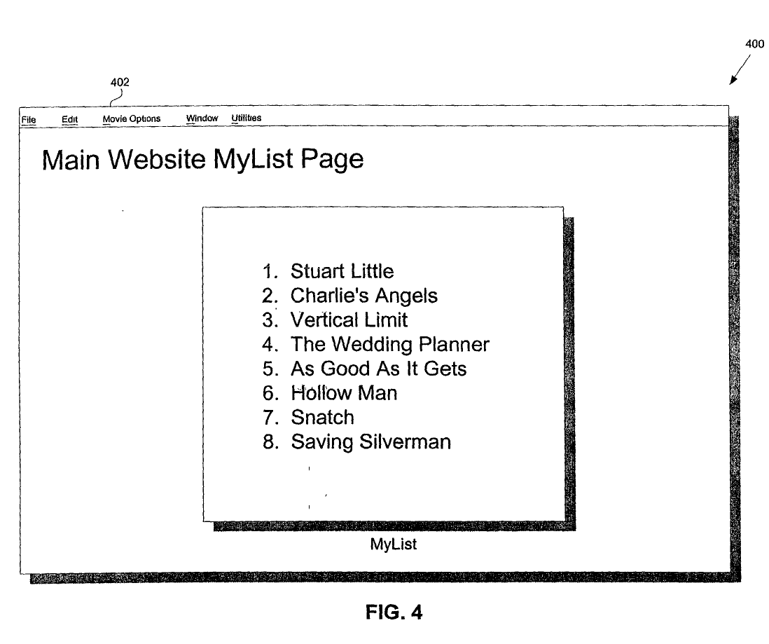

Selecting the “MyList” icon or area 214 on options menu 204, as shown in FIG. 2, provides the user with a Mylist page 400, an example of which is shown in FIG. 4. The “MyList” page shows a list of one or more content items (such as movies) designated by the user as being of interest during a previous visit to the main website. A list such as MyList may be generated by a “Remember Engine” which may, for example, be implemented in software routines on the UND or, more preferably, on the website server (or associated processor). As with the Recommendation page 300, the user may then select one of the content items (such as movies) on MyList, in a manner similar to that described above for the Recommendation page. The user may also be presented with options on menu bar 402 on MyList page 400 that allows the user to select a particular content item (such as a movie). Once selected, additional information about the selected content item (for example, movie) will be displayed to the user. Such additional information may be displayed on a portion of the MyList page, on a window opened over the MyList page, or on a separate page to which the user is directed (such as an official page for the content item, for example, an official movie page for a particular movie) upon selecting a content item in the list.

Alternatively, or in addition, once a content item on the MyList page is selected, the user may be presented with the option of purchasing or otherwise obtaining a license to access the selected content (such as, a license to rent the selected movie), for example, by displaying information or indicia for placing an order for the selected content. Such order information may be displayed on a portion of the MyList page, on a window opened over the MyList page, or on a separate page to which the user is directed (such as an Order Page) upon selecting a content item in the list.

The main website provides the user with a powerful and versatile interface for selecting, ordering and/or accessing the content items (for example, movies) made available by the service. In example embodiments, the main website may be configured with an easy-to-use, recognizable or readily understandable format for browsing or searching content items in a manner simulating browsing and searching the shelves of a traditional (brick-and-mortar) business establishment (such as a traditional video rental store). In addition or alternatively, the main website may be configured to enable the user to organize the available content items (such as movies) in ways that are different and more advantageous than the typical organization of a traditional business establishment (such as a video rental store). For example, the main website may enable a user to browse through categories or genres of content items (for example, browse through movies by movie genres such as westerns, drama, horror, comedy, or the like), similar to categories or genres used in traditional business establishments (for example, traditional video rental stores) to organize content items. However, unlike a typical brick-and-mortar business establishment (for example, video rental store), the main website may enable the user to browse through virtual shelves of virtual boxes or packages (for example, virtual video boxes), not only by the genres discussed above, but also by additional categories related to the content, such as, but not limited to, author, actor/actress, movie director, movie producer, date, rental cost, date of release or authorship or other suitable category. Thus, the user is provided with much more powerful and versatile browsing options than are available in a typical business establishments (such as video rental stores). Similarly, the main website provides the user with a powerful search engine that allows the user to search for content items (such as movies) by categories, characteristics or genres (such as author, actor/actress, director, producer, date, and rental cost).

Another advantage of the main website is that the format in which content items (such as movies) are browsed or searched may be adjusted to the preferences of the user. As examples, the user may choose to simulate an experience of a typical video rental store by browsing or searching through virtual shelves of virtual packages or boxes (such as video tape boxes) or may adjust the main website to display text based lists of content (such as movies) through which to browse or search. Additionally, the user may choose to have the main website display content items (such as movie information, boxes or packages) in stacks or in a grid format.

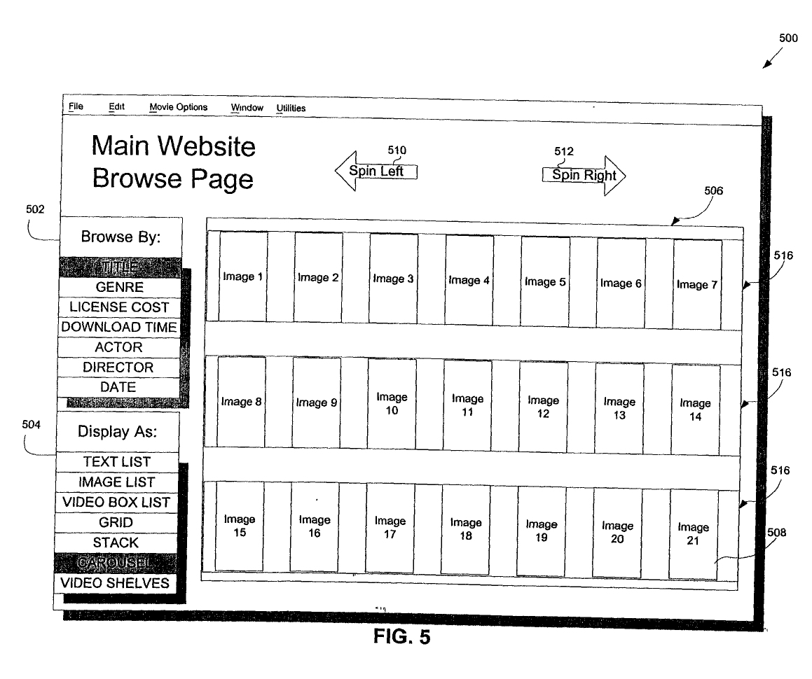

Another website page or display that may be included in the website is a Browse page. For example, selecting the “Browse” icon or area 216 on options menu 204, as shown in FIG. 2, takes the user to a browse page 500, as shown in FIG. 5. Browse page 500 provides selectable icons or areas for all of the content items (for example, movies) accessible through the service.

In one example embodiment, the Browse page 500 may present the user with various options, such as in the form of selectable icons or areas on an option menu 502, for organizing the content items (for example, movies) for browsing. For example, the user may browse by title, genre, license cost, or download time. The content items (for example movies) may be identified in a display area 506 in various ways, such as, but not limited to text lists, image lists, box or package representational images or lists, grids, or stacks, by selecting the appropriate button from option menu 504. Information 508 representing content items may be displayed in display area 506, as described above with respect to images 208 in FIG. 2.

As an example, if the method of organizing the browse feature is by title and the display method is by virtual carousel, the content items (for example, movies) may then be displayed by title in alphabetical order in a virtual carousel interface. In FIG. 5, the shaded icons or areas in the menus 502 and 504 represent a state in which the user has selected to browse content item information (such as movie information) 508 by title and to display representations of the content items (for example, box art from movie video boxes) in a virtual carousel display, i.e., in horizontal rows 516, which may be caused to appear to move or spin to the left or right by selecting icon or area 510 or icon or area 512, respectively, simulating the motion of a carousel. A user may interact with the display representations of content items presented on the Browse page in the same way as content item representations on the home page, for example, by selecting a content item (for example, movie) with a left or right click to view more information or purchase or obtain a license to access the selected content item, respectively.

Similar to the images 208 described above, images 508 may be virtual boxes (such as virtual video boxes). The Browse page 500 may also enable rotating box images, as described above, moving or spinning rows 516 of images 508 one at a time or in a group within a virtual carousel interface, for example, to simulate a carousel display rack or aisles of a typical brick-and-mortar business establishment (such as a video rental store).

The virtual carousel interface shown in FIG. 5 provides multiple virtual boxes or images presented in one or more rows 516 which may be moved by the user. The content items (such as movies) 508 appear to move sideways with a continuously animated action and variable speed to simulate a rack or carousel being rotated in front of the user, including a continued rotation (or momentum) prior to coming to a complete stop. Alternatively, rotation of the multiple rows of boxes provides a user with a simulation of walking along aisles of racks of packaged content items (such as video boxes within a video rental store). As described above with respect to images 208, a user may view the front and back of a box by virtual rotation of the image 508.

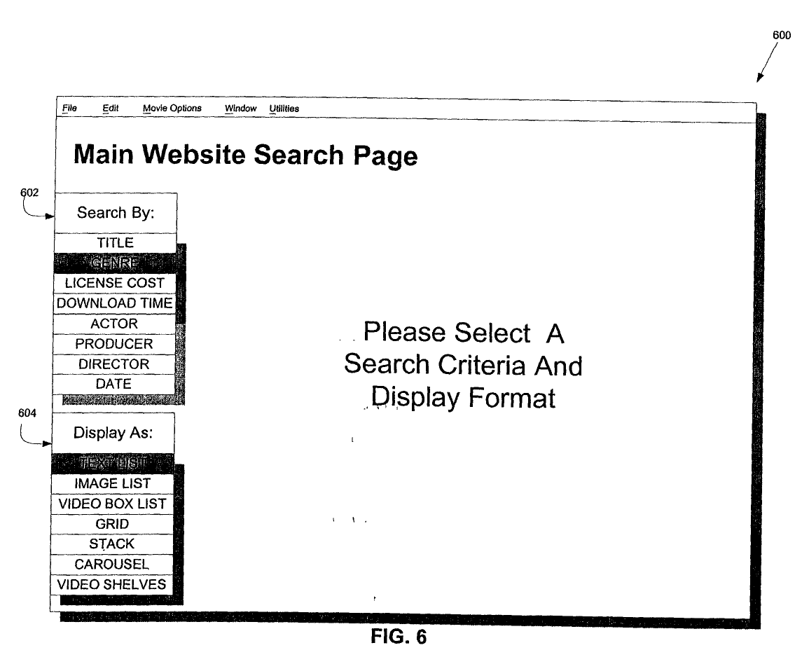

In a preferred embodiment, selecting the “Search” icon or area 218 on options menu 204, as shown in FIG. 2, takes the user to a search page 600, as shown in FIG. 6. In one embodiment, search page 600 will prompt the user to enter search and display criteria, for example with a displayed message requesting the user to select search criteria and/or display format.. The user may be presented with various options, in the form of selectable icons or areas on option menu 602, for searching among the available content items (such as movies) of the main website. For example, a user may search for content items (for example, movies) using various criteria, such as title, author, actor, director, producer, date, genre, license cost, or download time, or the like, as described above. The results of the search may be presented in various formats as well, including, but not limited to similar formats presented on the browse page 500, by selecting the appropriate icons or areas from option menu 604. Again, a user may interact with image representations of content items (such as text, icons, images of boxes or packages, or combinations thereof) presented on the search page in the same way as images representing content items (such as images 208 and 508) are presented on the home page 200 and browse page 500.

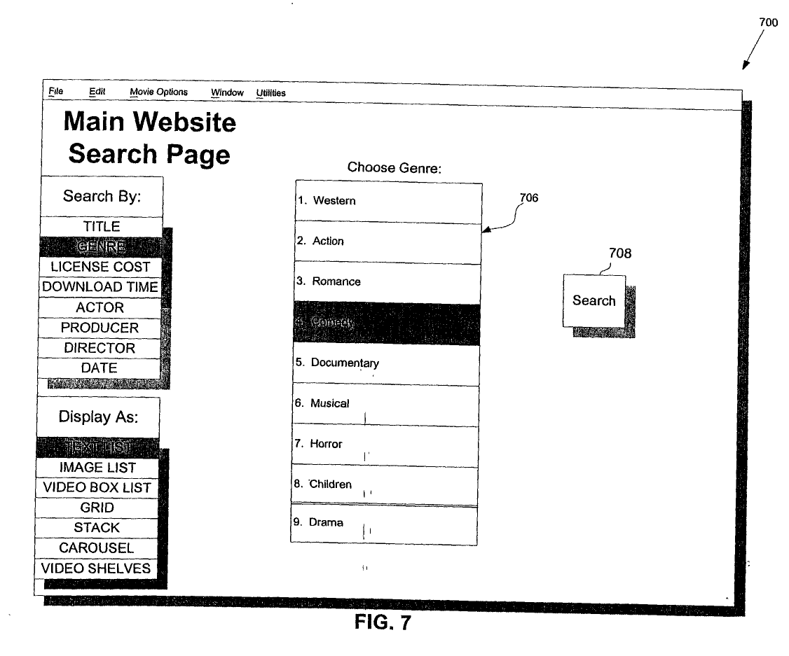

As a representative example shown in FIG. 6, the shaded icons or areas on option menus 602 and 604 show that the user has selected to search for content items (such as movies) according to genre and to display information identifying such content items in a text list. Accordingly, in one embodiment, a genre selection display box or window 706 may appear on search page 700, as shown in FIG. 7, from which the user may select among various genres of content (such as genres of movies as shown in FIG. 7). Again, the selection may be made in the various manners as described above with respect to selecting other selectable icons or areas. As shown in FIG. 7 by the shaded button in genre selection box 706, the user has selected “Comedy” as the desired genre.

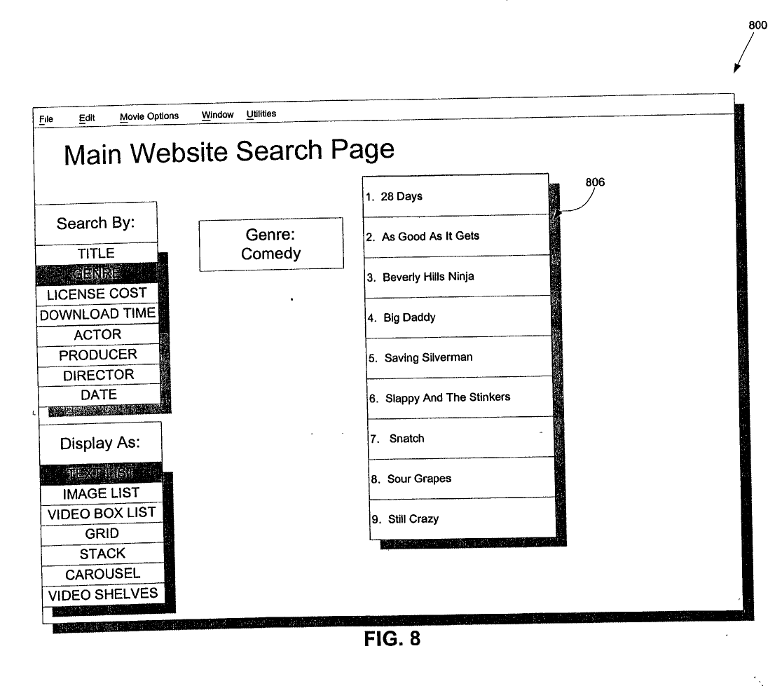

After the user makes a search criteria selection, the user may select a search icon or area 708 to complete the search. The main website's search engine will search for all the content items (for example, movies) classified according to the selected category (such as comedies, as shown on search page 800 in FIG. 8) available through the website service. The results of this search will then be presented to the user in the format selected by the user. Thus, in the present example, the results of the search are presented in text list 806, as shown in FIG. 8. The user may now select to view more details about one of the identified content items (for example, movies) or to purchase or otherwise obtain a license to access the content item (for example, to rent the movie), as described above. In some embodiments, selecting an item from text list 806 will result in an expanded text box appearing on search page 800. The expanded text box may contain additional information about the selected content item. Thus, in that embodiment, the user may not be taken to a new page to view more information about the selected movie.

In a preferred embodiment, the main website may also provide pages focussed toward specific content items for example movie pages containing information, such as promotional material, on specific movies. A focussed page (such as a movie page) is a web page serving as an access point to information, such as promotional material, facilities for ordering memorabilia, educational information or other information about or related to a particular content item (for example, a particular movie, such as a “Stuart Little” movie page dedicated to information relating to the movie, “Stuart Little”) or set of content items (for example a set of movies, including, but not limited to a series of related movies). A focussed page (such as a movie page) may include various information and functions, such as commercial transaction requests, or the additional information described above. A focussed page (such as a movie page) may be accessed, for example, by selecting a content item (such as a movie) and requesting the focussed page (for example, requesting the movie page) for the selected content item. The focussed page (for example, movie page) presentation may provide a more consolidated and discrete presentation of information focussed on the associated content item or set of content items, rather than large amounts of information for multiple, unrelated content items (for example, multiple, unrelated movies) on a single page.

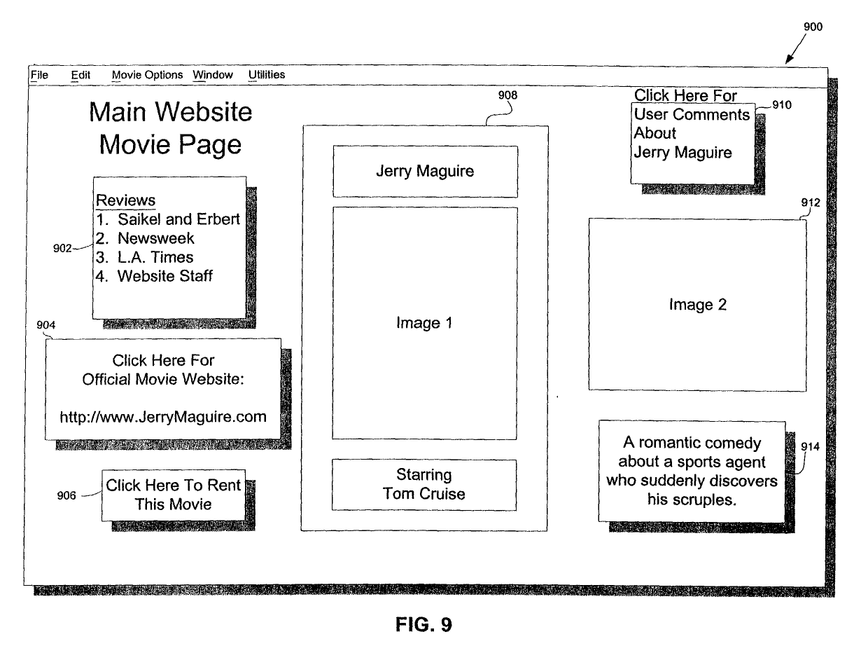

As an example, referring again to FIG. 5, if the user wishes to access a focussed page to see more information about a content item (such as a movie), the user may select an image 508 (or an image 208 on the home page shown in FIG. 2) representing the content item, for example, by left-clicking the mouse) within one of the rows 516 of the virtual carousel shown in display box 506. As a result, a page, window or other display containing focussed information, for example, as shown on movie page 900 in FIG. 9, may be displayed to the user.

In preferred embodiments, the focussed page (for example, movie page) 900 includes a larger version of the image 508 (208), such as a larger display of a virtual box (for example, virtual video box) 908, with the text of the box being easily viewable by the user. In addition, various information about the content item (for example, movie) may be displayed. The focussed page (for example, movie page) 900 may include a review area 902 for accessing reviews of the content item such as by professional reviewers (for example, movie reviews by professional movie reviewers). In one embodiment, the review area 902 includes a plurality of selections, to allow the user to choose a particular reviewer from a plurality of reviewers.

The focussed page (for example, movie page) 900 may include a user comments area 910 that may be selected by the user to read what fellow users of the main website have reported about the selected content item (for example, movie reviews or commentaries from peers). The focussed page 900, may include a hyperlink 904 to an official website associated with the selected content item or set of items, for example, an official movie website for a selected movie (such as a “Stuart Little” website dedicated to the movie “Stuart Little”). The hyperlink 904 allows the user to quickly jump to the official website for additional information, opportunities to order or purchase memorabilia, or the like. Display box 912 allows the user to see a clip or trailer of the selected content item (such as a movie clip or movie trailer). In one embodiment, a clip or trailer starts automatically, upon the user entering the focussed page 900. In other embodiments, a user may select (for example, click) an icon or area (such as the display box 912) to start a clip or trailer. A synopsis 914 of the selected content item (such as a movie synopsis) may also be included on focussed page 900.

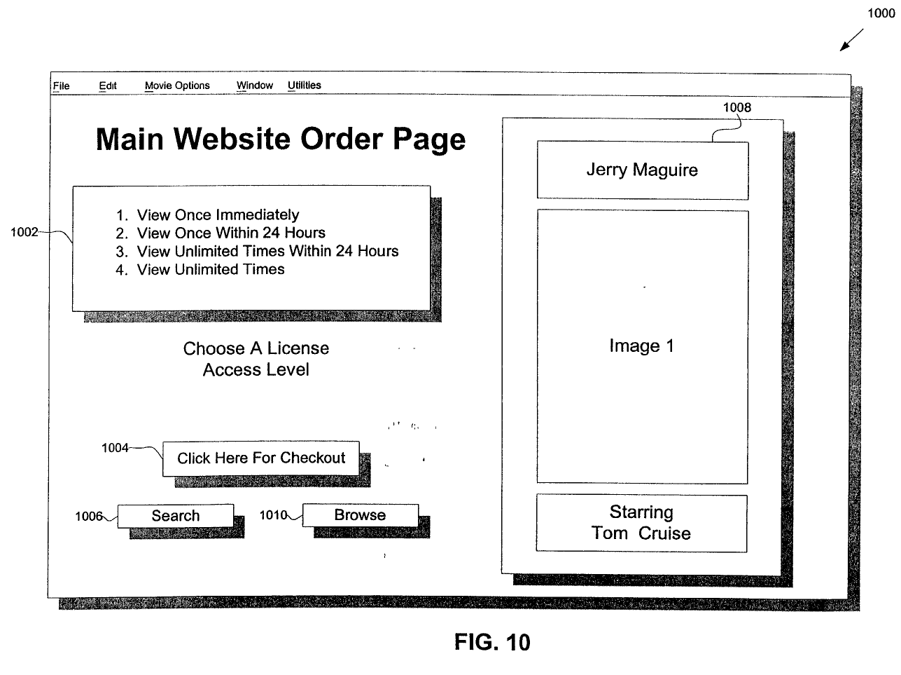

A selectable transaction icon or area 906 may be included so that the user may quickly enter a transaction to purchase or otherwise obtain a license to access the associated content item (for example, rent the selected movie) from the focussed page 900. In one embodiment, when the user enters a transaction to purchase or otherwise obtain a license to access a content item (such as, to rent a movie), for example, by selecting transaction icon or area 906, an order page, window or other display 1000 may be displayed to the user as shown in FIG. 10. The user may also jump to order page 1000 (or open an order window or display) from home page 200 by selecting a content item identified on the home page and then selecting the order page icon or area 220 on options menu 204, as described above. The user may also jump to the order page 1000 (or open an order window or display) from other pages, such as the Recommendation Page, the MyList page, the Browse page or the Search page, for example, by selecting a content item identified on one of those pages and then selecting an order icon or area or right-clicking on a mouse button, as described above.

In one embodiment, order page 1000 may present the user with a virtual box representation (such as a virtual video box) 1008 associated with the selected content item (for example, movie) and a list 1002 of license access levels from which the user may select. In an example embodiment, licensed access to content items (such as movies) may be defined in multiple levels, such as “view once immediately,” “view once during a window (for example, 24 hours),” “view unlimited times during a window,” and “view unlimited times,” as shown in list 1002. Thus a particular license will provide a defined level of access based on a defined number of times a content item (for example, a movie) may be viewed or otherwise accessed during a defined time window. In a further example embodiment, a user may upgrade a window at a reduced cost relative to an initial purchase. A license discount may also be provided to further licenses, if the user had previously purchased a license, such as a narrower license, for the same content item (for example, movie). Other discounts may also be provided, for example, for referrals to the website, downloading content items during off-peak hours, and receiving the content item otherwise than by downloading, for example by DVD distribution.

In an example embodiment, when an access level has been selected by a user, for example, from box 1002 in FIG. 10, the user may then choose to checkout by selecting the checkout icon or area 1004 on order page 1000. Alternatively, the user may continue to search or browse the main website by selecting search button 1006 or browse button 1010. These selectable icons or areas will take the user to search page 600 or browse page 500, respectively. In one embodiment, the user may build a list of orders and then checkout.

If the user has chosen a license access level for each content item (for example, movie) that the user wishes to access (for example, rent), the user may select a checkout icon or area 1004 on the Order page. As a result, a Checkout page, window or other display may be displayed to the user. The Checkout page may display a calculated charge and provides an interface for receiving electronic payment information from the user for the selected content item (for example, movie). The charge may be calculated by the website server (or an associated processor), for example, based on the selected access level, the selected content and/or other pre-defined factors. The checkout page may provide a user-friendly interface for a commercial transaction, such as a form to be completed or queries to the user for credit card information and confirmation of billing to the user's credit card. Once the checkout and payment transaction is completed, the user may be provided with a license corresponding to the selected content item and access level. In one embodiment, the license may define a time period (or time window) in which the license may be used.. Any suitable time window may be employed, including, but not limited to a twenty-four hour period, which commences once the movie is unlocked as further described below. Alternatively, the defined time window may commence once downloading of the selected content item is complete.

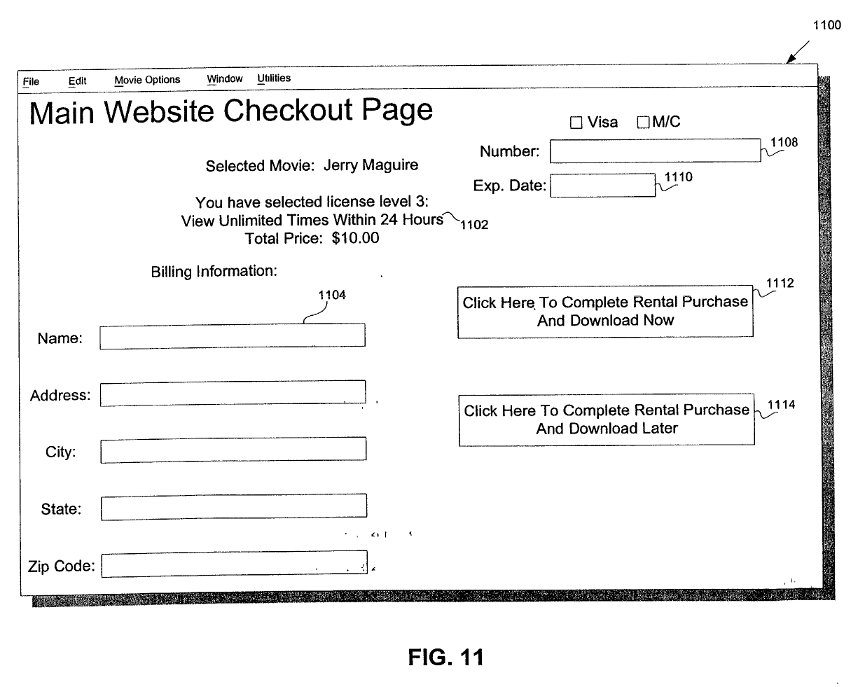

An exemplary checkout page 1100 is shown in FIG. 11. Checkout page 1100 may include a license (or access) level and price area 1102 which displays to the user the license (or access) level that the user has chosen and the corresponding price. Checkout page 1100 may include a billing address information area 1104 where the user may enter billing address information. Credit Card Number box 1108 and Expiration Date box 1110 may be included for entry of the user's credit card information. The user may fill in information in those boxes in any conventional manner, including, but not limited to locating a cursor in one of the boxes and inputting the relevant information with a standard user input device, such as a keyboard. When the user has filled in all the information requested by checkout page 1100 the user may select the “complete rental purchase and download now” icon or area 1112 to complete the transaction and immediately download the selected content item (for example, a movie file). Alternatively, the user may select the “complete rental purchase and download later” icon or area 1114 to complete the transaction at that time, but download the selected content item (for example, movie file) at a later time. The user may specify the time of download at the time of license purchase or may simply contact the main website again at a later time and request that the selected content item (for example, a movie file) be downloaded at that later time. In one embodiment, a check box may be provided on checkout page 1100 which, if checked, causes the information entered by the user to be retained by the website.

In one embodiment, the main website may include an interface for a fast and simple completion of commercial transactions. According to such embodiments, a user may complete a transaction, such as a purchase of a license (for example, to rent a movie), with a single action, such as a mouse-click or keystroke/key combination. In such an embodiment, a user may pre-register payment or billing information, for example, credit card information, with the website service. Such payment or billing information may be associated in the website database with the user identification information, such that the website server may draw upon that information to apply a payment or determine billing. In one embodiment, a user may have a pre-paid account, for example, pre-paid by the user during registration of the user with the website or at some time thereafter. The website server may take payments from a pre-paid account, by deducting a charge from the pre-paid total remaining in the user's account, automatically (invisible to the user) in response to a user placing an order or selecting a fast transaction. In another embodiment, the user may have pre-registered credit card, bank card, bank account or other payment information with the website service, such that the website server automatically draws or charges payments to the credit card, bank card, or bank account associated with the user, in response to the user placing an order or selecting a fast transaction. In further embodiments, this streamlined transaction feature may additionally be available from affiliate websites. Thus, a transaction may be carried out on the affiliate website by clicking on an icon for a content item (such as a movie) on the affiliate website, without displaying a web page from the main website.

In example embodiments, authentication of the license is based on a key (or code) derived from the user's computer system (or other storage device) and from the movie. The key (or code) may also include further information such as, but not limited to, time of download, location of the user's device, and the user's specific content player (for example, movie player software). Also, in preferred embodiments, the key (or code) information may be included in the downloaded movie.

In further embodiments, a “Flexible Viewing” feature enables the user's content player (for example, movie player software) to track the progress through the playing of the content (for example, to track how far the movie has been played) and to update licensing information, for example, to indicate that playback has not yet been completed. When the user later attempts to access the content item (for example, movie) to continue viewing, the license verification confirms that the content item (for example, movie) has not been completely viewed yet. Thus, the user is allowed to view a content item (for example, movie) in multiple sessions without purchasing additional licenses. Additional information may be included to track rewind, amount of time spent viewing, or other factors to control abuse. Thus, a threshold number of track rewinds, rewound length, viewing time or the like, may be set, such that the license will be revoked or expires, in the event that the user reaches a threshold.

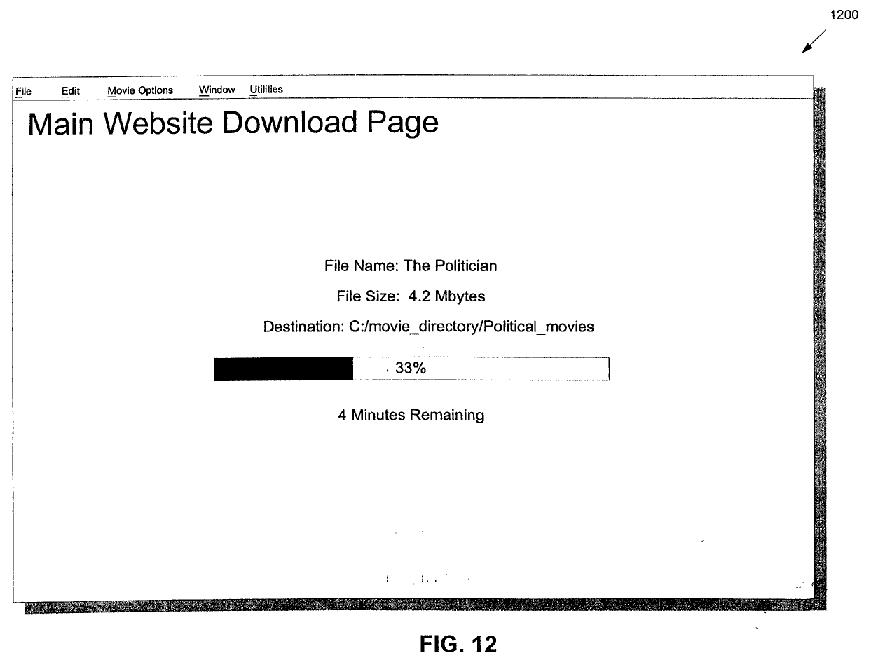

In one embodiment, once electronic payment is received, download page 1200 may be presented to the user, an example of which is depicted in FIG. 12. The download page 1200 may provide users with information regarding the file name and storage location for the downloaded content item (for example, movie file), such as, but not limited to, the file size and duration time of the download. In an example embodiment, an encrypted version of the content item (for example, movie file) is downloaded to the user. Once the user has downloaded the selected content item, the user may view (or otherwise access) the selected content item (for example, movie) using a content player (for example, movie player software application), such as, but not limited to, a Windows media player, a Real media player, video game player software, or the like, depending upon the type of content to be accessed or played.

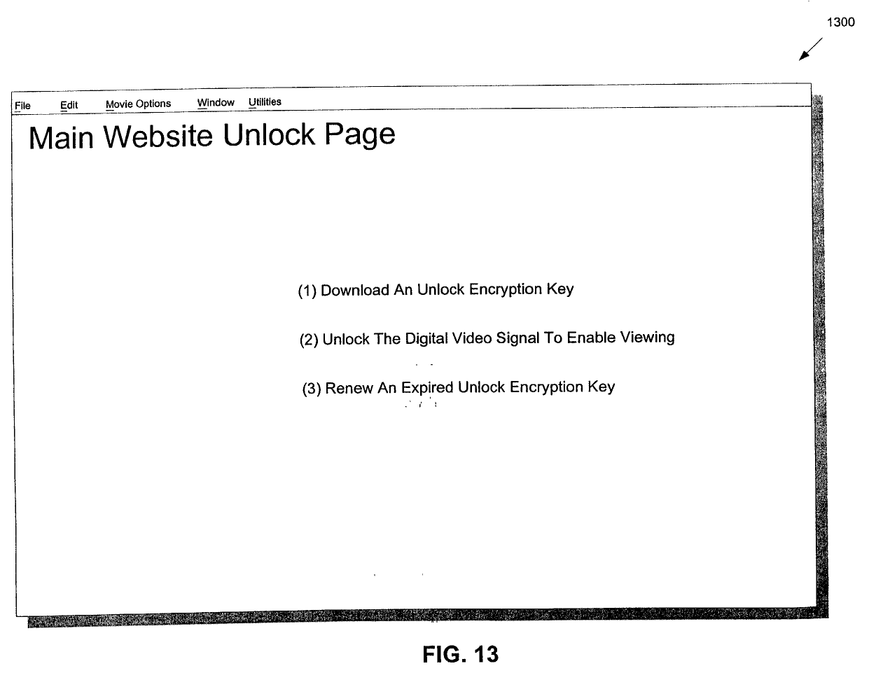

In one embodiment, in response to a user's attempt to access a downloaded content item (for example, view a downloaded movie) for which a license has not previously been verified, the content player (for example, movie player software) contacts the main website server (or an associated processor) to verify that the user has a proper license for the selected content item. In response, an unlock page, window or display 1300 may be presented to the user, an example of which is shown in FIG. 13. In an example embodiment, the unlock page 1300 offers an online user the following options: (1) Download An Unlock Encryption Key; (2) Unlock The Content To Enable Access (for example, unlock a digital video signal to enable viewing); and (3) Renew An Expired Unlock Encryption Key. The unlock page 1300 provides an unlock encryption key enabling the content player (for example, movie player software application) to convert the digital content (for example, a digital video signal) to a user perceptible form (such as a motion picture) during the defined period of time. The user may control playback similar to a VCR or DVD player utilizing pause, rewind, as well as other commands provided by the content player. If the user does not have a proper license for the selected movie, the user may be automatically taken or directed to order page 1000 to purchase a license.

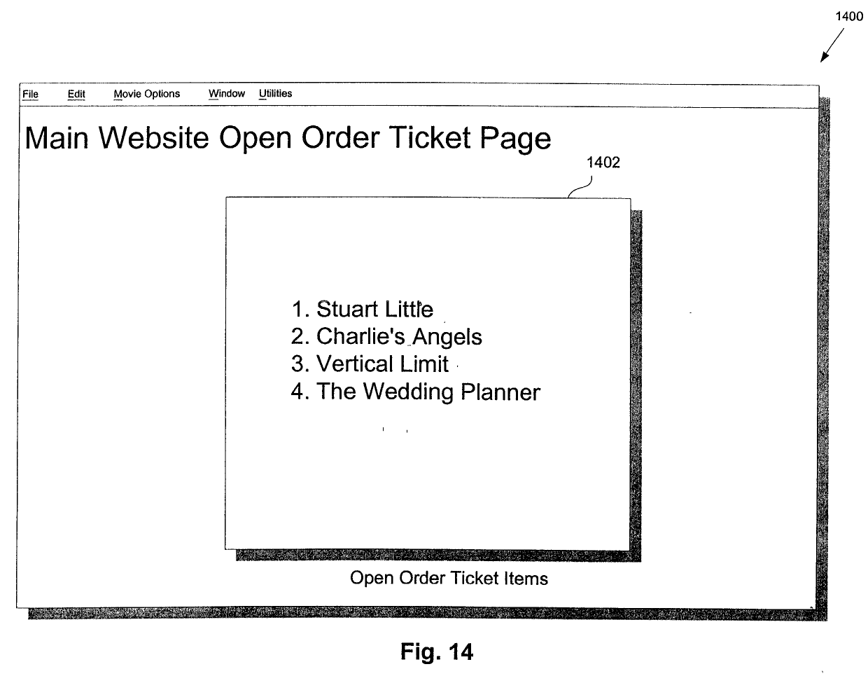

In one embodiment, the main website may enable the user to access an open order ticket page 1400, an example of which is shown in FIG. 14, which provides a user with a display 1402, listing one or more content items (for example, movies) for which the user has purchased or otherwise obtained a license (for example, purchased a rental license), but has not yet unlocked to view (or otherwise access). The user may access the open order ticket page 1400, for example, by selecting the open order ticket icon or area 222 on home page 200. In this way the user may quickly determine which downloaded content items (for example, movie files) the user has available and has not yet viewed (or otherwise accessed). If the user wishes to access a content item (for example, view a movie) listed in the display 1402, the user may select that content item (in any suitable manner, as described above with respect to the selection of content items from lists or displays in other pages), in which case the user will be taken to order page 1000.

Additional features of the main website include “Push Downloads.” A push download causes a content item (for example a movie) to be downloaded to the user, even though no license for the downloaded content item (for example, movie) has been purchased or otherwise obtained by the user. A push download may be requested by the user, for example, by the user highlighting a content item (for example by selecting the item with a cursor or other input mechanism) and a selecting push download icon or area 224 on home page 200. Alternatively, a push download may be performed automatically by the main website without any request from the user. When performed automatically, the main website may download a content item (for example, a movie) which the user has either previously designated using the Remember Engine or that has been selected for the user by the Recommendation Engine, or that has been otherwise selected for push downloading. The designated or selected content item (for example, movie) is downloaded even though it was not specifically requested by the user for push download. Thus, no license is purchased or otherwise obtained at the time of the push download. The user may later obtain a license to view (or access) the content item.

In one embodiment, the user may select multiple content items (for example, multiple movies) for push download without purchasing or otherwise obtaining licenses for those content items. The website may then establish a “Push Queue” from which the selected content items (for example, movies) would be sequentially downloaded to the UND or storage device associated therewith. In an example embodiment, a ‘Smart Push” feature may include the ability to evaluate user settings on the website and parameters of the UND or associated storage device, such as available storage capacity, in order to determine whether a particular push download operation should be performed.

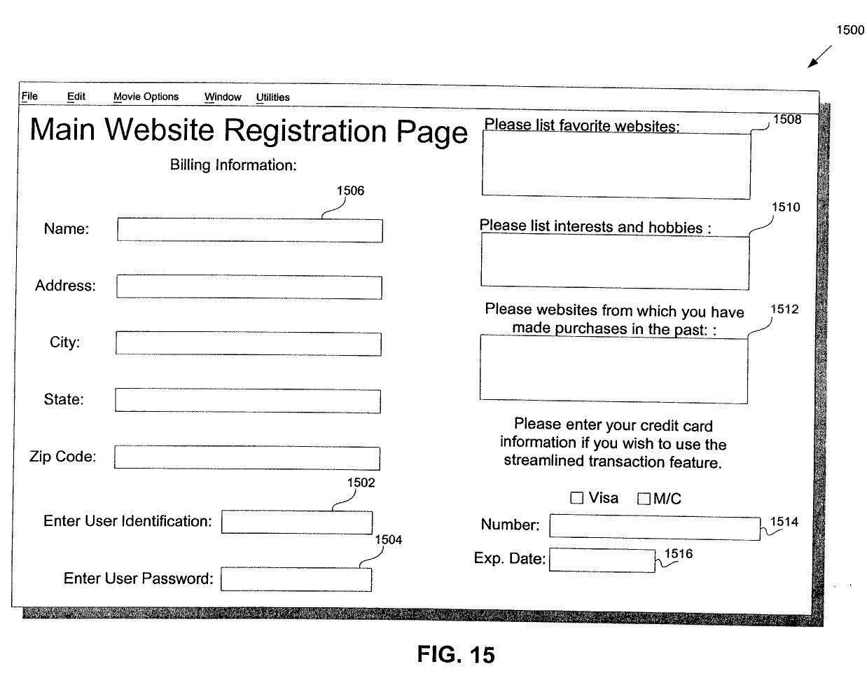

A new user may also register with the website to establish a user identifier and/or password. A user may register with the website through the home page 200 by, for example, selecting a register icon or area 226. In response, a registration page, window or other display 1500 will be displayed to the user, as shown in FIG. 15. Registration page 1500 may, for example, be a form to be completed including information boxes such as, but not limited to, user identification entry box 1502, password entry box 1504, billing information 1506, personal and marketing information boxes such as favorite websites box 1508 and interests and hobbies box 1510, web shopping habits box 1512, credit card number box 1514 and expiration date box 1516. The form may be completed in any conventional manner, such as described above with respect to FIG. 11.

In addition, in one embodiment, registration page 1500 will query the user for information about the user's device, preferably, automatically and transparently to the user, for example, by software routines that query the UND for such information. As described above, this information may then be used to provide proper support for the user's interaction (for example, to determine the type of streaming files to use). The user identifier associates the user with a customer account on the website. In a preferred embodiment, the customer account may be customized to the particular user. For example, the home page includes a message, greeting the user by name.

Registration provides the user with enhanced access to the services of the website, such as purchases. Additional services may include the open order ticket and the MyList features, as described above. Registration may also provide a basis for customization of services to the user. Registration may provide to the website demographic and marketing information relating to the user, as well as a basis for tracking user activity, as described above.

In preferred embodiments, demographic information may be used to compile a database of licensing information for various regions (for example, countries or other geographic zones) that may be maintained by the website. The website may access the database to provide parameters for available licenses for a content item (for example, a movie) according to the determined geographical location of a user requesting the content item. The license database may also indicate schedules of releases and rules for controlling licenses based on, for example, a scheduled or contracted release of the content item (such as a scheduled theatrical release to pay per view, home video, etc.). The website advantageously uses the license information to determine what content items (for example, movies) are available at a particular time for a particular place and under what conditions (for example, cost, duration, method of download, media classification). The determined availability may provide a basis for recommendations to users (for example, alternatives or similarly priced movies). The license database may also be used to indicate whether a particular content item is presently available or whether the user should be redirected to another source, as discussed above.

The licensing information may also be used for accounting to third parties, such as the studio owning a selected movie or an actor appearing in the movie. The geographical location of the user may be determined from one or a combination of factors, including the credit card supplied to the website, the Internet Protocol (IP) address of the user's computer system, geographical information provided by the operating system of the computer system, or certified Global Positioning System (GPS) data from the UND.

In further embodiments, marketing information obtained from user registration may be used to determine other websites visited by the user. This information may then be used to develop relationships with these websites. These affiliate websites may then provide links to the main website. The links may be to the main website home page 200 or to a focussed page (for example, a movie page) 900 for a specific content item available through the main website. A benefit, such as a percentage of revenue from each content item (for example, movie) for which a license is purchased, may be provided to the operator of the affiliate website from which the user was directed or the user's order was directed.

In further preferred embodiments, coupons for discounts and rebates on services offered by the main website or affiliate websites may be offered to the user as promotional gifts or rewards for specified activities, for example, referrals or multiple downloads. Coupons may also be offered for a purchase, such as the DVD for a movie, at an affiliate website from which the user entered the main website. The coupons may be tailored to the information derived from the user in the registration process.

In a further preferred embodiment, licenses for content bundles (for example, “Movie Bundles”) may be offered to the user based on user registration information. A content bundle (for example, Movie Bundle) may be a group of content items (for example, a group of movies) for which licenses may be purchased together at a discount. The bundles may be defined by the main website for specific content items (for example, specific movies), genres, numbers of content items, or the main website may provide an interface to the user for forming and designing a bundle from available content items and determining the cost of the needed licenses.

Various embodiments of the present invention may include one or more of the features, pages, displays and functions described above. One example embodiment includes all of the features, pages, displays and functions described above.

Therefore, apparatuses and methods for delivery of content to recipient processors over a network have been described. In one embodiment, a movie rental website is described which provides the downloading of movie files to customers across the Internet. Embodiments of the present invention further provide an interface that may be customized to simulate aspects of a typical video rental store, while at the same time providing the user with powerful and versatile browse and search options that are not available in a typical video rental store.

Embodiments of the present invention further provide an interface that may be customized to the interests of a particular user by providing a method for remembering content items (for example, movies) that the user may have shown an interest in during a previous visit to the website and by providing a method for recommending content items (for example, movies) and other merchandise available on the website to the user based upon the user's activities on the main website and other websites and/or upon information gathered about the user through the registration process.

It is to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed.

In addition, although example embodiments described herein are directed to a movie rental system for enabling online rental of digitally encoded movies, it will be appreciated by those skilled in the art that the teaching of the present invention may be applied to other systems. In fact, systems for online rental of digitally encoded music or other audio content, games, books, television programming, radio programming, and any other content (audio, video, text, etc.) which may be digitized or encoded and stored as an electronic file are within the teachings of the present invention, without departing from the scope and spirit of the present invention.

Having disclosed exemplary embodiments and the best mode, modifications and variations may be made to the disclosed embodiments while remaining within the scope of the invention as defined by the following claims.

What is claimed is:

1. A user interface for use with a content item delivery apparatus, comprising:
a plurality of representations of the content items, the plurality of representations of the content items being user selectable; and
a plurality of user selectable operators for performing functions on the content items;
wherein the user interface enables the user to obtain a license associated with the content item, the license corresponding to an access level, the access level defining a different set of conditions, wherein the license associated with the selected content item includes access level information corresponding to an access level selected by the user.

2. The user interface recited in claim 1, further comprising:
a server network device located at a first node, the server network device being programmed to provide the user interface;
a user network-enabled device located at a second node and communicatively coupled to the server network device via a network, the user network-enabled device being programmed to access the user interface.

3. The user interface recited in claim 2, wherein the network comprises the Internet and the user interface comprises a main website.

4. The user interface recited in claim 1, wherein the plurality of representations of the content items comprise virtual representations of the content items.

5. The user interface recited in claim 4, wherein the virtual representations of the content items comprise a plurality of selectable virtual video boxes.

6. The user interface recited in claim 5, wherein the plurality of selectable virtual video box representations of the digital video signals comprise a virtual carousel of selectable virtual video boxes, the virtual carousel being capable of simulated movement so that the spinning of a video rental store carousel is simulated.

7. The user interface recited in claim 5, wherein the plurality of selectable virtual video box representations of the digital video signals comprise a virtual shelf of selectable virtual video boxes, the virtual shelf being capable of simulated movement so that searching a video rental store shelf is simulated.

8. The user interface recited in claim 5, wherein the plurality of selectable virtual video box representations of the digital video signals may be manipulated in 3D so that all sides of the virtual video box representations of the digital video signals may be viewed by the user.

9. The user interface recited in claim 1, further comprising at least one display area for staging a user-perceptible form of the content items.

10. The user interface recited in claim 9, wherein the at least one display area on the user interface for staging of the content item in a user-perceptible form comprises a streaming box for playing at least one of a movie clip and a trailer of a movie.

11. The user interface recited in claim 1, further comprising a plurality of website pages for performing at least one of facilitating searching of the content items, facilitating browsing of the content items, facilitating licensing of the content items, facilitating downloading of the content items, and facilitating display of the content items.

12. The user interface recited in claim 1, wherein the plurality of user selectable operators comprise selectable virtual buttons for at least one of moving between a plurality of web pages, choosing a search option, choosing a browse option, and choosing a display option.

13. The user interface recited in claim 12, wherein the search options comprise at least one of a movie genre, a movie actor, a movie director, a movie producer, a movie date, a movie download time, and a movie license cost.

14. The user interface recited in claim 12, wherein the browse options comprise at least one of a movie genre, a movie actor, a movie director, a movie producer, a movie date, a movie download time, and a movie license cost.

15. The user interface recited in claim 12, wherein the display options comprise at least one of a text list, an image list, a video box list, a grid, a stack, a virtual carousel, and a video shelf.

16. The user interface recited in claim 11, further comprising a recommendation page for displaying to the user at least one representation of the content items determined to be of interest to the user by a recommendation engine based on user criteria.

17. The user interface recited in claim 16, wherein the content items determined to be of interest to the user by the recommendation engine is staged in the at least one display area on the user interface.

18. The user interface recited in claim 16, wherein the recommendation engine is implemented in software routines.

19. The user interface recited in claim 16, wherein the user criteria comprises at least one of the user's answers to a questionnaire provided by the user interface, the user's activities on the user interface, the user's shopping habits, and the user's activities on other websites.

20. The user interface recited in claim 11, further comprising a MyList page for displaying to the user at least one representation of the content items marked as being of interest to the user by a remember engine.

21. The user interface recited in claim 20, wherein the remember engine marks the content items based on previous user activities on the user interface.

22. The user interface recited in claim 21, wherein the previous user activities comprise selecting a representation of the content items to obtain more information about the selected content items.

23. The user interface recited in claim 5, further comprising a movie page for displaying for a selected movie at least one of reviews of the selected movie, a hyperlink for an official movie website for the selected movie, an enlarged virtual video box representation of the selected movie, comments about the selected movie, a synopsis of the selected movie, a clip of the selected movie, and a trailer of the selected movie.

24. The user interface recited in claim 5, further comprising an order page for requesting a selected movie based on a defined level of access.

25. The user interface recited in claim 24, wherein the defined level of access comprises a license which is purchased by a user so that the user may play the selected movie a defined number of times during a defined time window.

26. The user interface recited in claim 5, further comprising an open order page for displaying a list of movies that have been ordered by the user but which the user has not yet viewed.

27. The user interface recited in claim 5, further comprising an unlock page for providing a key to the user to allow the user to convert a downloaded digital video signal to a user-perceptible form.

28. The user interface recited in claim 1, wherein the plurality of representations of the content items comprise textual representations of the content items.

29. The user interface recited in claim 5, wherein selecting the plurality of virtual representations of the content items by left-clicking a mouse displays additional information about the selected content items.

30. The user interface recited in claim 5, wherein selecting the plurality of virtual representations of the content items by right-clicking a mouse takes the user to an order page for the selected content items so that the user may purchase a license for the selected content items.

31. The user interface recited in claim 1, wherein the plurality of user selectable operators comprise selectable menus for at least one of printing, saving files, editing text, and selecting movie options.

32. A method for implementing a user interface for use with a content items delivery apparatus, comprising:
displaying a plurality of representations of the content items on the user interface, the plurality of representations of the content items being user selectable;
providing a plurality of user selectable operators for performing functions on the content items;
licensing selected content items to the user based on a defined level of access, the license corresponding to an access level, the access level defining a different set of conditions, wherein the license associated with the selected content items includes access level information corresponding to an access level selected by the user.

33. The method recited in claim 32, further comprising:
programming a server network device to provide the user interface, the server network device being located at a first node;
providing access to the user interface by a user network-enabled device located at a second node and communicatively coupled to the server network device via a network.

34. The method recited in claim 32, wherein the network comprises the Internet and the user interface comprises a main website.

35. The method recited in claim 32, wherein displaying the plurality of representations comprises displaying a plurality of virtual representations of the content items.

36. The method recited in claim 35, wherein displaying the plurality of virtual representations of the content items comprises displaying a plurality of selectable virtual video boxes representing digital video signals.

37. The method recited in claim 36, wherein displaying the plurality of selectable virtual video box representations of the digital video signals comprises displaying a virtual carousel of selectable virtual video boxes, the virtual carousel being capable of simulated movement so that the spinning of a video rental store carousel is simulated.

38. The method recited in claim 36, wherein displaying the plurality of selectable virtual video box representations of the digital video signals comprises displaying a virtual shelf of selectable virtual video boxes, the virtual shelf being capable of simulated movement so that searching a video rental store shelf is simulated.

39. The method recited in claim 36, wherein displaying the plurality of selectable virtual video box representations of the digital video signals comprises allowing the selectable virtual video box representations of the digital video signals to be manipulated in 3D so that all sides of the virtual video box representations of the digital video signals may be viewed by the user.

40. The method recited in claim 32, further comprising providing at least one display area for staging a user-perceptible form of the content items.

41. The method recited in claim 40, wherein providing at least one display area for staging a user-perceptible form of the content items comprises providing a streaming box for playing at least one of a movie clip and a trailer of a movie.

42. The method recited in claim 32, further comprising providing a plurality of website pages for performing at least one of facilitating the searching of the content items, facilitating browsing of the content items, facilitating licensing of the content items, facilitating downloading of the content items, and facilitating display of the content items.

43. The method recited in claim 32, wherein providing the plurality of user selectable operators comprises providing selectable virtual buttons for at least one of moving between a plurality of web pages, choosing a search option, choosing a browse option, and choosing a display option.

44. The method recited in claim 43, wherein providing selectable virtual buttons for choosing a search option comprises providing selectable virtual buttons for choosing at least one of a movie genre, a movie actor, a movie director, a movie producer, a movie date, a movie download time, and a movie license cost.

45. The method recited in claim 43, wherein providing selectable virtual buttons for choosing a browse option comprises providing selectable virtual buttons for choosing at least one of a movie genre, a movie actor, a movie director, a movie producer, a movie date, a movie download time, and a movie license cost.

46. The method recited in claim 43, wherein providing selectable virtual buttons for choosing the display options comprises providing selectable virtual buttons for choosing at least one of a text list, an image list, a video box list, a grid, a stack, a virtual carousel, and a video shelf.

47. The method recited in claim 42, further comprising providing a recommendation page for displaying to the user at least one representation of the content items determined to be of interest to the user by a recommendation engine based on user criteria.

48. The method recited in claim 47, further comprising staging the content items determined to be of interest to the user by the recommendation engine in the at least one display area on the user interface.

49. The method recited in claim 42, further comprising providing a MyList page for displaying to the user at least one representation of the content items marked as being of interest to the user by a remember engine.

50. The method recited in claim 36, further comprising providing a movie page for displaying for a selected movie at least one of reviews of the selected movie, a hyperlink for an official movie website for the selected movie, an enlarged virtual video box representation of the selected movie, comments about the selected movie, a synopsis of the selected movie, a clip of the selected movie, and a trailer of the selected movie.

51. The method recited in claim 36, further comprising providing an order page for requesting a selected movie based on a defined level of access.

52. The method recited in claim 36, further comprising providing an open order page for displaying a list of movies that have been ordered by the user but which the user has not yet viewed.

53. The method recited in claim 36, further comprising providing an unlock page for providing a key to the user to allow the user to convert a downloaded digital video signal to a user-perceptible form.

54. A user interface for use with a content delivery apparatus, comprising:
a plurality of images associated with content items, the plurality of images associated with content items being user-selectable; and
at least one area of the user interface for display of streaming video;
wherein the at least one streaming video display area displays streaming video of content corresponding to a content item associated with at least one of the plurality of user selectable images.

55. The user interface recited in claim 54, wherein the content item to be displayed in the at least one streaming video display area of the user interface is selected automatically by the content delivery apparatus.

56. The user interface recited in claim 55, wherein the content item displayed in the at least one streaming video display area of the user interface is selected automatically based on at least one of pre-defined user preferences and promotional considerations.

57. The user interface recited in claim 54, wherein the content item to be displayed in the at least one streaming video display area of the user interface is chosen by a user by selecting one of the plurality of representations.

58. The user interface recited in claim 54, wherein the content item displayed in the at least one streaming video display area is a trailer for one of the content items associated with one of the plurality of images.

59. The user interface recited in claim 54, wherein the content item displayed in the at least one streaming video display area is a representative segment for one of the content items associated with one of the plurality of images.

60. A user interface for use with a content delivery apparatus, comprising:
a plurality of images associated with content items, the plurality of images associated with content items being user-selectable;
wherein the plurality of images associated with content items comprise virtual representations of a standard box or package in which the content items are typically contained in a conventional store.

61. The user interface recited in claim 60, wherein virtual representations of a standard box or package comprise virtual representations of a standard video box.

62. The user interface recited in claim 60, wherein virtual representations of a standard box or package comprise virtual representations of a standard music compact disc box.

63. A virtual carousel interface for use with a content delivery apparatus, comprising:
a plurality of images associated with content items, the plurality of images associated with content items being user-selectable;
a plurality of rows, each row having a plurality of images, each image associated with a respective content item, the plurality of images being user-selectable; and
means for simulating lateral motion of images in each row to simulate boxes on a carousel rack.

64. A method for recommending content items to users of a content delivery apparatus, comprising:
storing user preference data representing possible preferences of a given user or group of users;
determining particular content items that may be of interest to a particular user based on the stored user preference data; and
displaying to the user, on a user interface, user-selectable images associated with the content items determined to be of interest to the user.

65. The method recited in claim 64, wherein determining particular content items that may be of interest to a particular user comprises programming a processor to determine the particular content items based on the stored user preference data.

66. The method recited in claim 65, wherein programming the processor to determine the particular content items comprises programming the processor to track user activity to determine content item preferences of the user.

67. The method recited in claim 66, wherein the user activity comprises at least one of previous purchases, previous selections of content items, and software programs operated by the user.

68. The method recited in claim 64, wherein determining particular content items that may be of interest to a particular user comprises collecting user responses to questionnaires.

69. A method for generating a record of content items designated by a user of a user interface as being of interest, comprising:
tracking user activity to determine content items that the user has previously accessed;
maintaining a record of the content items that the user has previously accessed;
displaying to the user, on a user interface, user-selectable images associated with the content items that the user has previously accessed.

70. The method recited in claim 69, wherein tracking user activity comprises programming a processor to track user activity.

71. The method recited in claim 69, wherein maintaining the record of the content items that the user has previously accessed comprises maintaining the record in a database accessible by a server network device.

72. The method recited in claim 69, wherein displaying to the user, on a user interface, user-selectable images associated with the content items that the user has previously accessed comprises displaying user-selectable representations of the content items in a user-selectable text list.

73. A method for authorization of a license for content, the license being transferred from a first user network-enabled device to a second user network-enabled device, comprising:
transferring the content from the first user network-enabled device to the second user network-enabled device;
connecting the second user network-enabled device to a server network device, the server network device providing a user interface;
obtaining a license for the content;
wherein the license allows the second user network-enabled device access to the content in a user-perceptible form under conditions defined in the license.

74. The method recited in claim 73, wherein connecting the second user network-enabled device to the server network device comprises connecting to a website on the Internet.

75. The method recited in claim 73, wherein transferring the content from the first user network-enabled device to the second user network-enabled device comprises copying the content to a computer readable disc, transporting the computer readable disc to the location of the second user network-enabled device, and copying the content from the computer readable disc to the second user network-enabled device.

76. The method recited in claim 73, wherein transferring the content from the first user network-enabled device to the second user network-enabled device comprises downloading the content from the first user network-enabled device to the second user network-enabled device over a network.

77. The method recited in claim 73, wherein transferring the content from the first user network-enabled device to the second user network-enabled device comprises the second user network-enabled device accessing content residing on the first user network-enabled device through a file-swapping user interface provided by the server network device, the file-swapping user interface allowing access to and transfer of content, the content residing on a plurality of user network-enabled devices, the plurality of user network-enabled devices being connected to the file-swapping user interface.

78. The method recited in claim 77, further comprising selection by the user of the second user network-enabled device of content residing on the first user network-enabled device and requesting transfer of the selected content to the second user network-enabled device.

79. The method recited in claim 78, further comprising transferring the selected content from the first user network-enabled device to the second user network-enabled device.
